(19) United States
(12) Patent Application Publication
(10) Pub. No.: US 2008/0207267 A1
(43) Pub. Date: Aug. 28, 2008

(54) System for Data Transmission Between a Machine and/or Installation and a Service Unit

(75) Inventor: Horst Gose, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/067,394

(22) PCT Filed: Aug. 11, 2006
(86) PCT No.: PCT/EP2006/065243

§ 371 Date: Mar. 19, 2008

(30) Foreign Application Priority Data
Sep. 19, 2005 (DE) 10 2005 044 649.3

(51) Int. Cl. H04M 1/00

(52) U.S. Cl. 455/557

(57) ABSTRACT

The invention relates to a machine and/or an installation (6) and to a service unit, with the machine and/or the installation (6) having a control device (1) and a mobile radio unit (4), with the control device (1) being connected to a mobile radio unit (4) for transmission of data, with the mobile radio unit (4) being designed in such a manner that it can be dialled from a service unit (9) using a telephone number allocated to it, and the data can be transmitted via a mobile radio system (8) to the service unit (9). The invention allows worldwide transmission of data of a machine and/or installation (6).

The invention relates to a machine and/or installation and to a service unit. In this context, the machine can be arranged as machine tool, production machine and/or as a robot.

In such a machine, good and quick service at the machine when problems occur or in service cases is only possible on the basis of an authentic accurate description of the symptoms and the exact data of the machine. In particular, when an acute problem occurs on site at the machine, appropriately trained personnel or an expert of the manufacture is frequently not on site. Previously, it has been attempted in such a case to convey as much information as possible to the expert, such as, e.g. a problem, location and machine description which he needs for solving the problem, e.g. by means of telephonic communication (or other personally initiated communication). The information needed by the expert for solving the problem must be absolutely authentic, i.e. it must correspond to the situation on site at the machine. Because of the complexity of the machine data, however, the problem of authentic machine description, in particular, necessitates trained personnel which, as a rule, is not available on site at the machine. The consequence is that the problem could not be solved, or only after many questions, by the expert who could be e.g. on another continent.

The invention is based on the object of providing for the worldwide transmission of data of a machine and/or installation.

This object is achieved by a machine and/or installation, wherein the machine and/or installation has a control device and a mobile radio unit, wherein the control device is connected to a mobile radio unit for transmitting data, wherein the mobile radio unit is arranged in such a manner that it can be dialed by a service unit via a telephone number allocated to it and the data can be transmitted to the service unit via a mobile radio system.

This object is also achieved by a service unit, wherein the service unit has a computing device and a communication unit, wherein the computing device is connected to the communication unit for transmitting data, wherein the communication unit is arranged in such a manner that it can dial via a telephone number a mobile radio unit of a machine and/or installation according to one of claims 1 to 10 and data can be transmitted via a mobile radio system from the machine and/or installation to the service unit.

A first advantageous embodiment of the invention is characterized by the fact that the service unit can be dialed by the mobile radio unit via a telephone number allocated to it. This provides for automatic dialing of the service unit from the machine and/or installation, e.g. in the case of a problem.

Furthermore, it is found to be advantageous if trace data, production data, usage data, software data, system data, identification data and/or data of a hardware component of the machine and/or installation are provided as data. The above-mentioned data allow the expert to analyze the problem quickly and reliably and then to submit proposals for solving the problem to the operator on site.

It is also found to be advantageous if the hardware component of the machine and/or installation is identified by means of an RFID chip and the data of the hardware component of the machine and/or installation are determined by means of the RFID chip.

This provides for automatic authentic identification of the hardware component of the machine and/or installation.

It is also found to be advantageous if the mobile radio unit is arranged as cell phone or cell phone module. Using a cell phone or cell phone module as mobile radio unit allows the invention to be implemented in a particularly cost-effective manner.

It is also found to be advantageous if the mobile radio system is arranged as mobile radio system supported by means of ground stations. Using a ground-based mobile radio system provides for a cost-effective mobile connection to the machine and/or installation.

It is also found to be advantageous if the local position of the machine and/or installation can be determined by means of the mobile radio system. This provides for a local determination of the position of the invention and/or installation in a simple manner.

It is also found to be advantageous if the machine and/or installation has a GPS receiver which determines data in the form of position data of the site of the machine and/or of the installation, wherein the position data can be transmitted to the service unit via the mobile radio system. Using a GPS receiver, the position data of the site of the machine and/or of the installation can be determined with great accuracy and transmitted to the service unit via the mobile radio system.

It is also found to be advantageous if the mobile radio system is arranged as satellite-based mobile radio system. Using a satellite-based mobile radio system provides for access to the data, e.g. even in thinly settled regions which normally do not have a ground-based mobile radio system.

It is also found to be advantageous if the control device is connected to the mobile radio unit via a universal serial bus for transmitting data. A universal serial bus represents a standardized bus connection.

It is also found to be advantageous if data can be transmitted encrypted to the service unit via the mobile radio system. This prevents the data from being acquired by unauthorized persons.

In this context, the machine can be arranged as machine tool, production machine and/or robot. An application of the invention is particularly advantageous particularly in these types of machines since the problems listed above occur frequently in these machines. Naturally, the invention can also be used in other technical fields, however.

It is also found to be advantageous if the service unit can be dialed by the mobile radio unit via a telephone number allocated to it. This provides for automatic dialing of the service unit by the machine and/or installation, e.g. in the case of problems.

It is also found to be advantageous if the communication unit is arranged as cell phone or cell phone module. Using a cell phone or cell phone module as mobile radio unit allows the invention to be implemented particularly cost effectively.

It is also found to be advantageous if the mobile radio system is arranged as mobile radio system supported by means of ground stations. Using a ground-based mobile radio system provides for a cost-effective mobile connection to the machine and/or installation.

It is also found to be advantageous if the local position of the machine and/or installation can be determined by means of the mobile radio system and the position is indicated at the service unit. This provides for a local determination of the position of the machine and/or installation in a simple manner.

It is also found to be advantageous if position data of the site of the machine and/or installation, determined by a GPS receiver, can be transmitted to the service unit via the mobile radio system. Using a GPS receiver, the position data of the site of the machine and/or of the installation can be determined with great accuracy and transmitted to the service unit via the mobile radio system.

It is also found to be advantageous if the computer device is connected to the communication unit via a universal serial bus for transmitting data. A universal serial bus represents a standardized bus connection.

It is also found to be advantageous if the computing device is arranged as laptop. Using a laptop, e.g. a service expert can be reached in mobile fashion at any location and immediately solve the problem.

Furthermore, it is found to be advantageous if the data can be transmitted encrypted to the service unit via the mobile radio system from the machine and/or installation. This prevents the data from being acquired by unauthorized persons.

Furthermore, a method for transmitting data between a machine and/or installation and a service unit is found to be advantageous.

Advantageous embodiments of the machine and/or installation and/or of the service unit are obtained analogously to the advantageous embodiment of the method and conversely.

An exemplary embodiment of the invention is shown in the drawing and will be explained in greater detail in the text which follows, wherein:

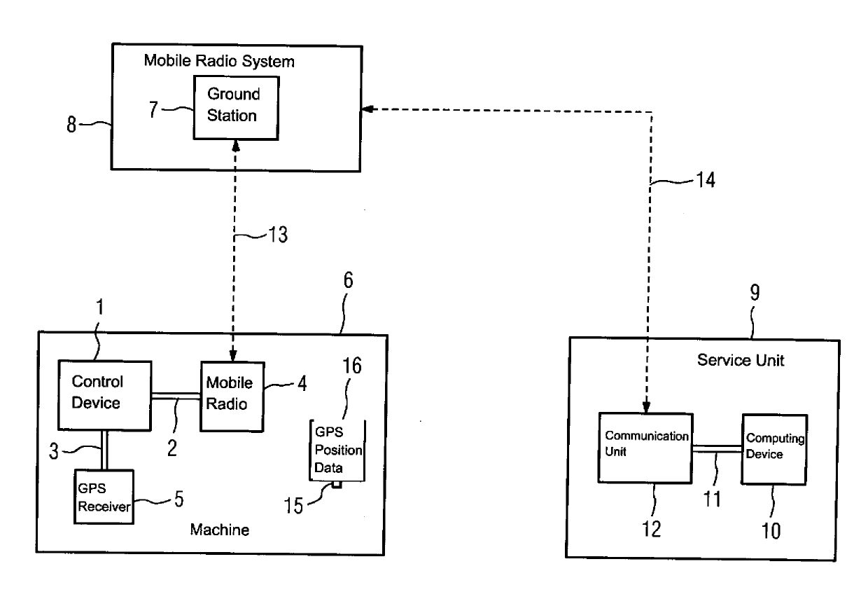

FIG. 1 shows a system for data transmission between a machine and a service unit.

FIG. 1 shows a transmission of data from a machine 6 via a mobile radio system 8 to a service unit 9 in the form of a block diagram. The machine 6 has a control device 1 for controlling the machine 6. The control device 1 can be present, e.g. in the form of a numeric control of the machine 6. The control device 1 is connected to a mobile radio unit 4, which is arranged as cell phone in the exemplary embodiment, via a bus 2 which is embodied as universal serial bus (USB) in the exemplary embodiment. However, the mobile radio unit 4 can also be arranged as cell phone module which only has the essential components of a cell phone necessary for the transmission. The cell phone module can be present, e.g. in the form of a plug-in card. The control device 1 is also connected to a GPS (Global Positioning System) receiver via a bus connection 3. Furthermore, the machine 6 has a hardware component 16 as part of the exemplary embodiment of the machine 6, on which a RFID (Radio Frequency Identification) chip 15 is mounted. Naturally, the machine 6 has other components which, however, for the sake of clarity, are not shown since they are unimportant for understanding the invention.

The mobile radio unit 4 is connected by radio to a ground station 7 which is part of a mobile radio system 8 for transmitting data which is shown by a dual arrow 13 drawn dashed. The mobile radio system 8, as part of the exemplary embodiment, is present in the form of a mobile radio system supported by means of ground stations. The ground station 7 is present in the form of a transmit and receive mast as part of the exemplary embodiment. The mobile system 8 can be arranged, e.g., in the form of a GSM network (Global Systems for Mobile communication) or a UMTS system (Universal Mobile Telecommunication System). For exchanging the data, the mobile system 8 is connected to a service unit 9, particularly a communications unit 12 which is arranged as cell phone module in the exemplary embodiment. This is represented by a dual arrow 14 drawn dashed. However, the communications unit 12 can also be arranged as fixed-network connection. In this case, the connection 14 represents a fixed-network connection. Seen physically, the connection to the mobile radio system 8 is thus established via a fixed network in this case.

The service unit 9 has a computing device 10 which is connected to the communications unit 12 via a bus connection 11 which is arranged as universal serial bus connection in the exemplary embodiment. The service unit 9 can be present, e.g. in the form of a service center. However, it can also be mobile in that the computing device 10, e.g., is arranged as laptop. In this context, the service unit 9 can be far removed, e.g. on another continent from the machine 6. In each case, a telephone number is allocated to the mobile radio unit 4 and the communications unit 12 via which the respective unit can be dialed.

In the case of a fault or problem at the machine 6, e.g., an expert of the manufacturer of the machine 6 is informed about the occurrence of the fault by telephone by, e.g. the operator of the machine. Using the service unit 9, the expert can now access the data of the machine 6. For this purpose, the telephone number of the mobile radio unit 4 is dialed by the communications unit 12 and in this way a connection is established between the machine 6 and the service unit 9. The data are then transmitted from the control device 1 to the computing device 10 via the mobile radio system 8 to the computing device 10. On the basis of the data of the situation at the machine 6, which is now authentically present, the expert who operates the service unit 9 can now perform an analysis of the fault. Thus, the operator 6 on site does not need to know any technical details about the machine 6. The data are authentic, i.e. they match the situation actually existing at the machine 6. As data, e.g., trace data, production data, usage data, software data, system data, identification data and/or data of hardware components of the machine can be transmitted. Before the data transfer from the machine 6 to the service unit 9 is initiated, the identity of the service unit 9 is verified. If necessary, the data can also be transmitted encrypted. In particular, e.g. the hardware components on which an RFID chip is mounted can be automatically recognized by the control 1 and their data (e.g. hardware type) can be transmitted to the service unit 9.

However, it is also possible that in the case of a fault on the machine 6, the control device 1 automatically detects the fault and the mobile radio unit 4 automatically dials a telephone number allocated to the communication unit 12 and in this way establishes a connection between the control device 1 and the computing device 10. The data can then be transmitted automatically and stored on the computing device 10, and the service unit 9 informs the expert, e.g. by peeping or a display, that a fault case is present at the machine 6.

Apart from the data already mentioned above, it is of great advantage for eliminating a problem if, apart from the abovementioned data, the local position of the machine 6 can also be determined and is indicated at the service unit 9. The expert can thus determine precisely where the machine 6 is located.

If the mobile radio system is arranged as a mobile radio system supported by means of ground stations as in the exemplary embodiment, the local position of the machine and/or installation can be determined by means of the mobile radio system through the knowledge with which ground station 7 the mobile radio unit 4 is communicating. If the radio signal of the mobile radio unit 4 is received by a number of ground stations 7 of the mobile radio system 8, the accuracy of the position determination of the machine can be increased. Such services are offered by operators of mobile radio systems.

As an alternative or in addition, the local position of the machine can also be determined by means of the GPS receiver 5 integrated in the machine 6 and the position data at the site of the machine, determined in this way, can be transmitted to the service unit 9 via the mobile radio system 8. This provides for a highly accurate localization of the machine 6.

However, the mobile radio system 8 can also be arranged, not as mobile radio system supported by means of ground stations as in the exemplary embodiment, but also as satellite-based mobile radio system. In this embodiment of the invention, localization by means of the ground station 7 is no longer possible but the position of the machine 6 can be determined by means of the GPS receiver 5 as before and transmitted to the service unit 9.

Naturally, it is also possible that data such as, e.g. a software update or parameters are transmitted from the service unit 9 to the machine 6 and are stored there.

In the context of the invention, a technical installation such as, e.g. a production plant and/or e.g. a power station can be understood to be an installation.

Due to the fact that the local position of the machine and/or installation can be determined, e.g. by means of the invention, the sites of service centers and spare parts stores can be optimized selectively, e.g., by the manufacturer of the machine and/or the installation.

Furthermore, the invention can be used for performing preventative maintenance on the machine and/or the installation by evaluating the data of the machine and/or installation, e.g. by means of trend analysis, and then the machine and/or installation operator being informed at the necessary time by the manufacturer of the machine and/or the installation about maintenance work which will shortly become necessary.

1-22. (canceled)

23. A machine comprising:
a mobile radio unit having an assigned telephone number and configured to be accessed by a service unit via a dial-up connection;
a control device connected to the mobile radio unit for transmitting data, said data being transmitted to the service unit via a mobile radio system supported by terrestrial stations, wherein the mobile radio system is configured to determine a local position of the machine.

24. The machine of claim 23, wherein the machine comprises at least one of a machine tool, a production machine and a machine configured as a robot.

25. The machine of claim 23, wherein the service unit has an assigned telephone number and is configured to be dialed by the mobile radio unit via the assigned telephone number.

26. The machine of claim 23, wherein the data include trace data, production data, usage data, software data, system data, identification data or data of a hardware component of the machine, or a combination thereof.

27. The machine of claim 23, wherein the data include data of a hardware component of the machine, wherein the hardware component is identified by an RFID chip and the data of the hardware component of the machine are determined from the RFID chip.

28. The machine of claim 23, wherein the mobile radio unit is implemented as a cell phone or a cell phone module.

29. The machine of claim 23, wherein the control device is connected to the mobile radio unit for data transmission via a universal serial bus.

30. The machine of claim 23, wherein the data are transmitted to the service unit in encrypted form.

31. A service unit comprising:
a communication unit configured to dial a mobile radio unit of a machine, said mobile radio unit having an assigned telephone number; and
a computing device connected to the communication unit for transmitting data, wherein the data are transmitted to the service unit from the machine via a mobile radio system supported by terrestrial stations, wherein the mobile radio system is configured to determine a local position of the machine, with the determined position being indicated to the service unit.

32. The service unit of claim 31, wherein the service unit has an assigned telephone number and is configured to be dialed by the mobile radio unit via the assigned telephone number.

33. The service unit of claim 31, wherein the communication unit is implemented as a cell phone or a cell phone module.

34. The service unit of claim 31, wherein the computing device is connected to the communication unit for data transmission via a universal serial bus.

35. The service unit of claim 31, wherein the computing device is implemented as a laptop.

36. The service unit of claim 31, wherein the data are transmitted to the service unit in encrypted form.
